(19) United States
(12) Patent Application Publication
(10) Pub. No.: US 2015/0245121 A1
(43) Pub. Date: Aug. 27, 2015

(54) ACOUSTIC SYSTEM

(71) Applicants: Maksym CHYZHOV, (US); Kostyantyn YUN, (US)

(72) Inventors: Maksym CHYZHOV, Odessa (UA); Kostyantyn YUN, Odessa (UA)

(21) Appl. No.: 14/622,980

(22) Filed: Feb. 16, 2015

(30) Foreign Application Priority Data
Feb. 24, 2014 (UA) U 2014 01715

(51) Int. Cl. H04R 1/02

(52) U.S. Cl. CPC H04R 1/02

(57) ABSTRACT

Invention relates to the field of acoustic systems used to convert electrical signal into sound, and the design of the housing where the electroacoustic loudspeaker is mounted and may be used in household and industrial applications as an acoustic system. The acoustic transducer has a housing, made from coconut endocarp, containing at least one opening for mounting a loudspeaker, and can have additional openings for wires and/or connectors to the signal source, sound-absorbing or dampening materials, mounting elements, for example, hooks for mounting with use of a flexible cord or any other similar fastening elements, connectors, phase inverter, electronics unit, protective decorative mesh or cloth. The proposed acoustic system provides improved sound quality by reducing the level of parasitic acoustic resonances, excited by the loudspeaker in the housing during sound generation by the loudspeaker's membrane.

### RELATED APPLICATION DATA

The current patent application claims priority to Ukranian application No. u2014 01715 filed on Feb. 24, 2014.

### FIELD OF INVENTION

The invention relates to the field of acoustic systems designed for converting electrical signals into sound, namely, to the design of the housing where the electroacoustic transducer (loudspeaker) is mounted within, which may be used in household and industrial applications as an acoustic system.

### BACKGROUND

From prior art related to the analyzed field, the closest analog by a set of features to the claimed invention is an acoustic system comprising a housing, wherein the inner surface does not contain ribs, which is made a continuous round body-spheroid, ovaloid, or ellipsoid of revolution, such that the inside surface of the housing, defining the empty volume inside, closely matches the outside surface, while the inner volume is connected to the external environment by openings where, at the least, one of which serves as a mount for the loudspeaker, moreover the housing is made from isotropic material obtained from a mixture of hardened synthetic cohesion material and solid mineral fillers (EP 1220568A2 MKP: H04R 1/28, publ. 29 December. 2000)

The claimed invention matches a known acoustic system along the following set of essential features, namely, including a housing implemented as a three-dimensional body, such that the outer surface does not have ribs and the inner volume contains a cavity with surface equidistant from the outer surface and contains a minimum of one opening.

However, the known acoustic system does not provide the technical results of the claimed invention, which is due to the properties of the material from which it is prepared—a mixture of hardened synthetic cohesion material and solid mineral fillers, which have isotropic properties that are characterized by identical mechanical properties, such as hardness, in all directions, and the use of large mass and dimensions of this type of design for eliminating parasitic acoustic resonances generated from the side of the loudspeaker, which is mounted in the housing.

### SUMMARY

The objective, which the claimed invention aims to solve is to improve the design of the acoustic system by changing the material used to make the housing: from isotropic to orthotropic, which will improve the quality of the acoustic signal by lowering levels of parasitic acoustic resonances, while simultaneously decreasing housing surface pulsation, excited by the electroacoustic transducer (loudspeaker) in the housing at the same time as the useful signal is generated by the loudspeaker membrane, while at the same time decreasing the housing mass and size.

In general, orthotropic materials have different material properties along each axis. Some examples of orthotropic materials include but are not limited to: wood, coconut endocarp, and metal rolled into sheet form. The present invention addresses implementation of the coconut endocarp of a particular geometry and size as a housing of an acoustic system.

The stated objective is solved in the claimed acoustic system, which comprises a housing implemented as a three-dimensional body, such that the outer surface does not have ribs and inner volume contains a cavity with surface equidistant from the outer surface and contains at least one opening, by, in accordance with the invention, using a coconut endocarp as the housing. The thickness of the endocarp may slightly vary as it is in natural coconut.

The claimed invention provides technical results comprising improvement of acoustic signal quality due to lower levels of parasitic acoustic resonances, excited by the loudspeaker in the housing at the same time as the useful signal is generated by the loudspeaker membrane, as well as higher mechanical resistance of the housing side to pressure changes that occur during operation of loudspeaker, due to the fact that the coconut endocarp has orthotropic properties, its inner and outer surfaces do not contain ribs, and it is a natural spheroid (ellipsoid or ovaloid of revolution) with walls of fibrous structure with mostly longitudinal orientation, and provides elimination of parasitic acoustic resonances during acoustic wave generation by vibrating membrane, as well as high mechanical strength at minimal wall thickness, characteristic of coconut endocarps, while simultaneously reducing mass and size of such an acoustic system.

The aforementioned is confirmed by acoustic measurements of the claimed acoustic system created in accordance with the invention claims.

### BRIEF DESCRIPTION OF THE DRAWINGS

FIG. 1 shows a diagram of the amplitude—frequency characteristic (AFC) and harmonic distortions for the Genius SP-P100 test device.

FIG. 2 shows a diagram of AFC and harmonic distortions of the claimed acoustic system with the Alphard ETP 66-1 loudspeaker.

The proposed acoustic system is illustrated using diagrams, which was shown in:

FIG. 3—front view of acoustic system

FIG. 4—cross-section A-A of FIG. 1

FIG. 5—cross-section A-A of FIG. 1 Assembled Acoustic System

### DETAILED DESCRIPTION OF SPECIFIC EMBODIMENTS

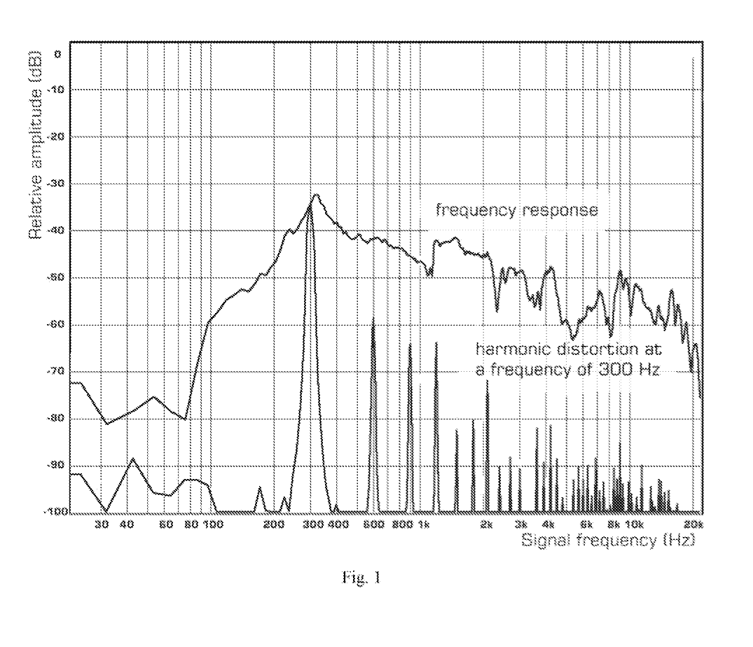

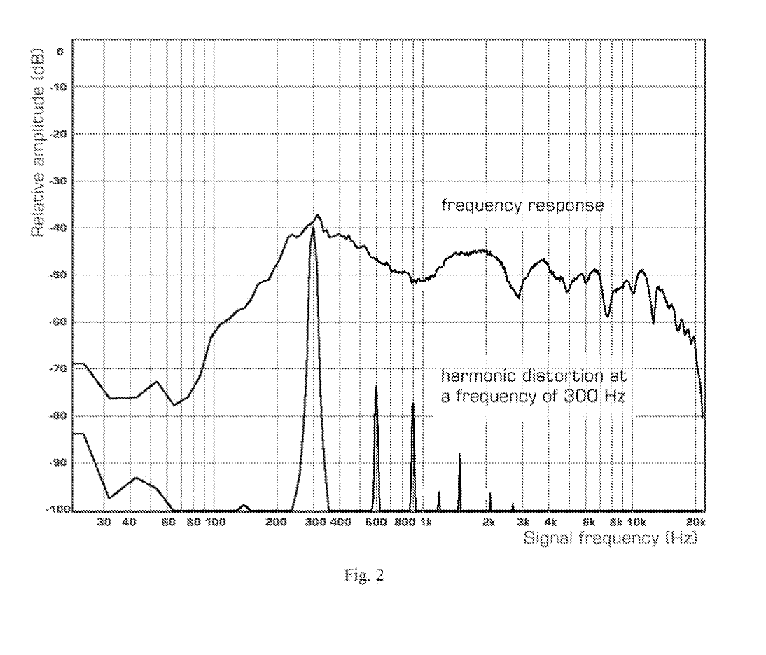

Both devices in FIGS. 1 and 2 were connected to an outer reference amplifier using test tones of 300 Hz as most revealing from the perspective of parasitic vibrations in the housing. Measurements were conducted in a space with localized sound absorption in the near field (0.1 m) by the measurement microphone Behringer ECM8000.

Based on diagrams shown in FIG. 1 and FIG. 2, it follows that operation of the loudspeaker Alphard ETP 66-1 in the acoustic design of the claimed invention, similar to the Genius SP-P100 test device loudspeaker, are characterized by much lower levels of harmonic distortions.

The choice to use loudspeaker Alphard ETP 66-1 and Genius SP-P100 system for comparative tests was made, as the qualitatively most revealing, since both used speaker drivers of similar quality and the difference in levels of nonlinear harmonic distortions was caused foremost by vibration of the plastic housing. Greater measurement accuracy requires specialized equipment and specialists, which, might influence only the quantitative, not the qualitative, side of comparative measurements and does not change the essence of the claimed invention.

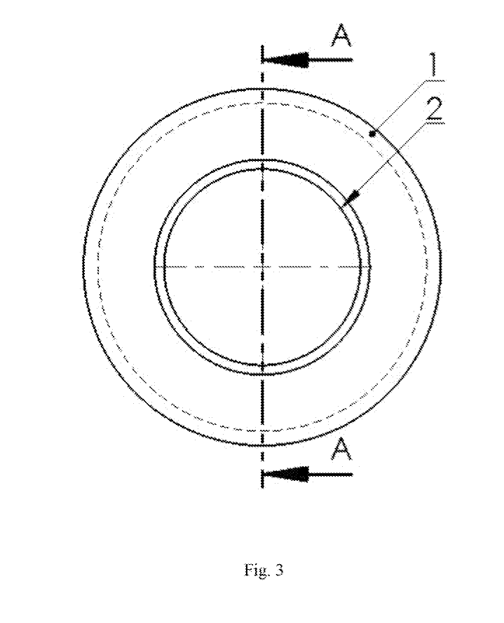

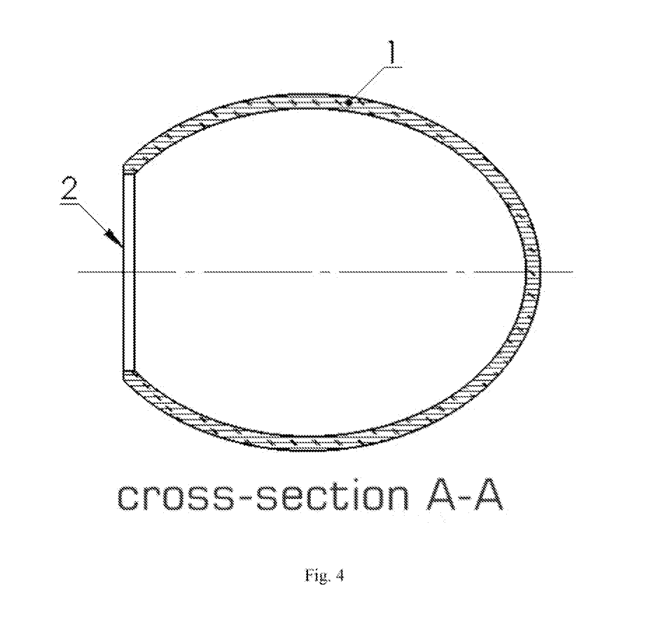

The proposed acoustic system shown in FIG. 3-5 comprises housing 1 made from coconut endocarp and contains at least one opening 2 for mounting the loudspeaker 3 and can also contain additional openings for cables and/or connectors for connection to a signal source (not shown in figures), sound-absorbing or dampening material 5, fastening elements 6, for example hooks for mounting with use of a flexible cord or any other similar fastening elements 6, connectors 7, phase inverter 8, electronics unit 9, protective mesh or cloth 10.

The proposed acoustic system is manufactured as follows.

The coconut chosen for producing the acoustic system housing 1 has the exocarp removed (outer shell), it also has a few natural openings aka “germination pores”, the liquid fraction is poured out, next a flat circular cross section with diameter less than or equal to the diameter of the outer part of the subsequently installed electroacoustic transducer (loudspeaker) 3, after which copra is removed from the inner cavity. The endocarp, produced in this manner, is then washed and dried. Inner and/or outer surfaces of the endocarp can be treated to prevent damage of a biological nature with corresponding preservation treatments and materials commonly used for this purpose.

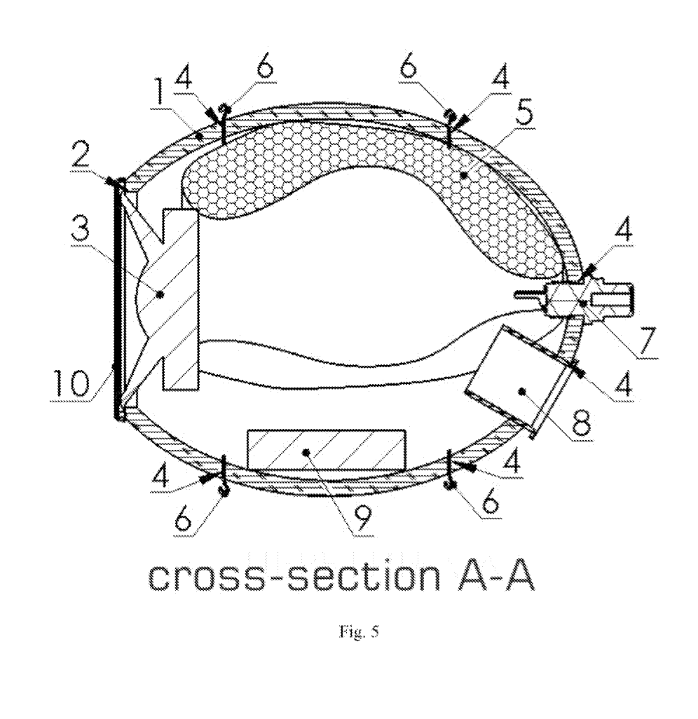

Also, the endocarp surface may be machined and/or dyed and/or saturated and/or coated with some materials and/or substances which would provide the required protective properties and/or create an attractive appearance. Afterwards, additional openings 4 can be made in the housing 1, if necessary, and all elements and materials traditionally used for the aforementioned purposes installed. For example, as shown in FIG. 5: sound-absorbing and/or dampening material 5, fastening elements 6, connectors 7 connected to the signal source (not shown in Fig.), phase inverter 8, electronics unit 9, protective decorative mesh or cloth 10, and, if necessary, an autonomous power source (not shown in Fig.) can be installed.

The proposed acoustic system operates as follows.

When supplying an electrical signal from the source (not shown in Fig.) to the loudspeaker 3 via either a wired connection, for example, using a connector 7, which can also supply electrical power to the acoustic system, or via a wireless connection, for example, using the electronic unit 9, the membrane fluctuations create two acoustic waves that are in antiphase: one wave is emitted from the front side of the loudspeaker 3 membrane and freely spreads out into the surrounding space, while the acoustic wave from the opposite side of the loudspeaker 3 membrane is either absorbed into the housing 1 using sound-absorbing material or dampening material or brought out into the surrounding space in inverted phase via phase inverter 8. Regardless of the method for eliminating an acoustic short circuit, i.e. when both antiphase acoustic waves interfere freely in space, the housing 1 provides the necessary hardness to minimize negative processes, namely—parasitic acoustic resonances and acoustic wave reemission into the surrounding space during housing pulsation and vibration due to properties of the coconut endocarp and its natural round form (spheroid, ovaloid, or ellipsoid) simultaneously provides minimization of diffraction phenomena that occur during propagation of acoustic waves around the housing 1.

The front of the loudspeaker 3 contains protective sound-transparent material 10, which also gives the acoustic system an appropriate outer appearance. The entire acoustic system may be housed in an enclosure, leaving the protective sound-transparent material 10 exposed, for aesthetic or mounting purposes (not shown in figures).

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. An acoustic system, comprising: a housing which is made as a continuous round body being spheroid, ovaloid, or ellipsoid of revolution, such that an inside surface of the housing, defining an empty inner volume inside, closely matches an outside surface, while the inner volume is connected to an external environment by openings where, least one opening in which a loudspeaker is placed, wherein the housing material is a coconut endocarp.

2. The acoustic system according to claim 1, wherein the coconut endocarp remains in its natural occurring shape modified only by an addition of at least one opening.

3. The acoustic system according to claim 1, wherein the body is made of a recycled coconut endocarp.

4. The acoustic system according to claim 1, wherein the coconut endocarp surface had experienced mechanical processing.

5. The acoustic system according to claim 1, wherein the coconut endocarp has been washed and dried.

6. The acoustic system according to claim 5, wherein the coconut endocarp has been treated with a preservative material or substance to prevent biological damage.

7. The acoustic system of claim 1, wherein the coconut endocarp material has been dyed.

8. The acoustic system according to claim 1, wherein the coconut endocarp has been saturated with another material or substance that is protective and/or creates an attractive appearance.

9. The acoustic system according to claim 1, wherein
the loudspeaker emitting a first acoustic wave from its front side toward the at least one opening, and emitting a second acoustic wave from its back side into the housing.

10. The acoustic system according to claim 9, further comprising an electrical connector placed through an additional opening in the housing that is connected via wires to the loudspeaker and connects the acoustic system to a signal source via a wired connection.

11. The acoustic system according to claim 9, further comprising an electronics unit placed in the housing which is connected via wires or wirelessly to the loudspeaker and connects the acoustic system to a signal source wirelessly.

12. The acoustic system according to claim 9, further comprising sound deadening or sound dampening material within the housing for absorbing or dampening of the acoustic wave from the back side of the loudspeaker.

13. The acoustic system according to claim 9, further comprising a phase inverter placed through an additional opening in the housing that allows the acoustic wave from the back side of the loudspeaker out into surrounding space in inverted phase.

14. The acoustic system according to claim 1, further comprising a protective mesh or cloth cover over the at least one opening.

15. The acoustic system according to claim 14, wherein the protective mesh or cloth cover is a sound-transparent material.

16. The acoustic system according to claim 1, further comprising fasteners anchored in the housing.

17. The acoustic system according to claim 1, further comprising a magnetic levitation system, the signal transmission and energy.

18. A method for reducing parasitic acoustic resonances and acoustic wave reemission into surrounding space during loudspeaker use, comprising:
housing a loudspeaker in a spheroid, ovaloid, or ellipsoid housing;
wherein the spheroid, ovaloid, or ellipsoid housing is made from an orthotropic material and the housing is a three-dimensional body with a ribless outer surface with at least one opening.

19. The method according to claim 18, wherein the housing is made from a coconut endocarp.

20. The method according to claim 18, further comprising minimizing of diffraction phenomena that occur during propagation of acoustic waves around the housing, the minimizing is performed by implementation of the endocarp as a housing.
